(19) United States
(12) Patent Application Publication
(10) Pub. No.: US 2004/0133642 A1
(43) Pub. Date: Jul. 8, 2004

(54) Server and application programming interface for distributed rendezvous

(76) Inventor: Pedro A. Vazquez, Grenoble (FR)

Correspondence Address: WAGNER, MURABITO & HAO LLP, Third Floor, Two North Market Street, San Jose, CA, 95113, US

(21) Appl. No.: 10/626,121

(22) Filed: Jul. 23, 2003

(30) Foreign Application Priority Data
Jul. 23, 2002 (FR) 0209345

(51) Int. Cl. G06F 15/16

(52) U.S. Cl. 709/204; 709/248

(57) ABSTRACT

Methods and systems method for managing code execution synchronization are described. A synchronization request message is received. The synchronization request message includes a node meeting identifier and a number of participants. A record is maintained of the node meeting identifier and number of participants for each received synchronization request message. In response to a received synchronization request message, a determination is made as to whether the number of records having the same node meeting identifier and the number of participants in a record having that node meeting identifier meet a given condition. In response to a record meeting the given condition, a synchronization-attained message is transmitted.

### RELATED APPLICATION

This Application claims priority to the French Patent Application, Number 0209345, filed on Jul. 23, 2002, in the name of Sun Microsystems, Inc., which application is hereby incorporated by reference.

### BACKGROUND OF THE INVENTION

1. Field of the Invention

The invention relates to a distributed computer system, such as a distributed computer system that provides a distributed software execution environment.

2. Related Art

A distributed computer system is composed of a group of nodes such as cooperating computers. Each node has programs to be executed. A program may be a set of code instructions. A program in execution may be designated as a process.

In a conventional (non-distributed) computer system, a process can adapt its execution according to the execution of other processes in the same computer. A process may adapt its execution to other process executions for different reasons. For example, a process may have to wait for another process to finish a task, several processes may have to begin their execution at the same time (start synchronization), or several processes may have to wait for each other to execute a code instruction.

In a distributed computer system, processes of nodes may also need to adapt their execution with the execution of processes of other nodes. However, in a distributed computer system, this can be problematic because nodes do not share memory and communicate only through a network.

The invention proposes a solution to this problem as well as similar problems.

### SUMMARY OF THE INVENTION

The present invention provides advances for synchronization between processes in a distributed computer system.

In one embodiment, the invention pertains to a method for managing code execution synchronization. A synchronization request message is received. The synchronization request message includes a node meeting identifier and identifies the number of participants. A record is maintained of the node meeting identifier and the number of participants for each received synchronization request message. In response to a received synchronization request message, a determination is made as to whether the number of records having the same node meeting identifier and the number of participants in a record having that node meeting identifier meet a given condition. For example, the given condition can be that the number of records having the same node meeting identifier is equal to or greater than the number of participants in a record having that node meeting identifier. In response to a record meeting the given condition, a synchronization-attained message is transmitted.

These and other objects as well as advantages of the present invention will no doubt become obvious to those of ordinary skill in the art after having read the following detailed description of the preferred embodiments, which are illustrated in the various drawing figures.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 is a block diagram of a computer upon which embodiments of the present invention can be implemented.

FIG. 2 is a block diagram of a distributed computer system upon which embodiments of the present invention can be implemented.

FIG. 3 is a distributed computer system with a rendezvous server according to one embodiment of the present invention.

FIG. 4 is data flow diagram indicating synchronization messages between a computer system and a rendezvous server according to one embodiment of the present invention.

FIG. 5 illustrates a flowchart of a method for managing received synchronization messages in the rendezvous server according to one embodiment of the present invention.

FIG. 6 illustrates a flowchart of a method for evaluating a sub-list in the rendezvous server according to one embodiment of the present invention.

### DETAILED DESCRIPTION OF THE INVENTION

Reference will now be made in detail to the various embodiments of the invention, examples of which are illustrated in the accompanying drawings. These drawings are placed apart for the purpose of clarifying the detailed description, and of enabling easier reference. They nevertheless form an integral part of the description of the present invention.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright and/or author's rights whatsoever.

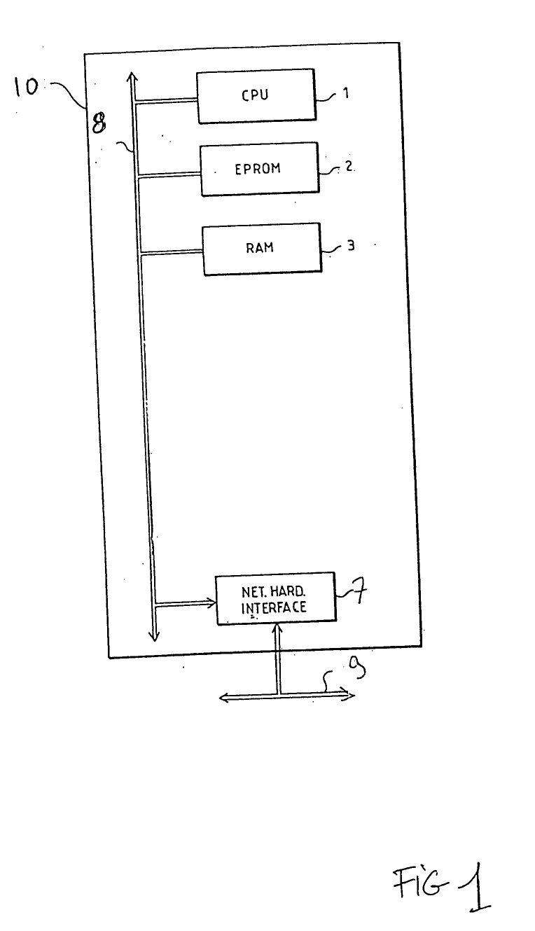

Embodiments of this invention may be implemented in a network comprising computer systems. An example of a computer system is shown in FIG. 1. In the example, computer system 10 includes a processor 1; a program memory 2 (e.g., an EPROM for BIOS); a working memory 3 (e.g., a RAM of any suitable technology such as SDRAM); and a network interface device 7 connected to a communication medium 9, itself in communication with other computers. Network interface device 7 may be an Ethernet device, a serial line device, or an ATM device, inter alia. Medium 9 may be based on wire cables, fiber optics, or radio-communications, for example.

Data may be exchanged between the components of FIG. 1 through a bus system 8, schematically shown as a single bus for simplification of the drawing. As is known, bus systems may often include a processor bus, e.g., of the PCI type, connected via appropriate bridges to e.g., an ISA bus and/or an SCSI bus.

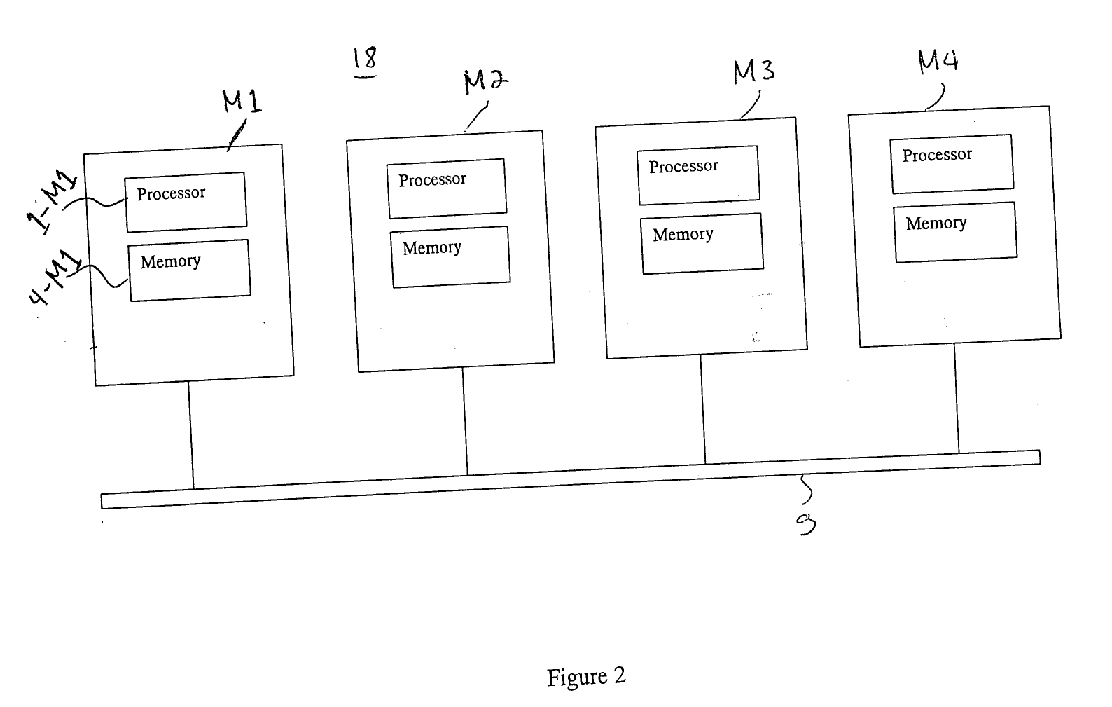

The computer system 10 may be a node amongst a group of nodes in a distributed computer system, such as that illustrated by FIG. 2.

FIG. 2 represents a distributed computer system 18 comprising different computer systems M1, M2, M3 and M4, which can be referred to as nodes. Each computer system M1-M4 is linked to the other computer systems via a communication medium 9 that may be based on Ethernet.

Each computer system M1-M4 is exemplified by computer system 10 of FIG. 1. For example, the hardware of computer system M1 includes processor 1-M1 and a memory 4-M1 (program or working memory) utilized with the processes executed in the computer system M1. When different processes are executed in computer system M1, for example, a process can adapt its execution responsive to the execution of one or more processes using the memory 4-M1.

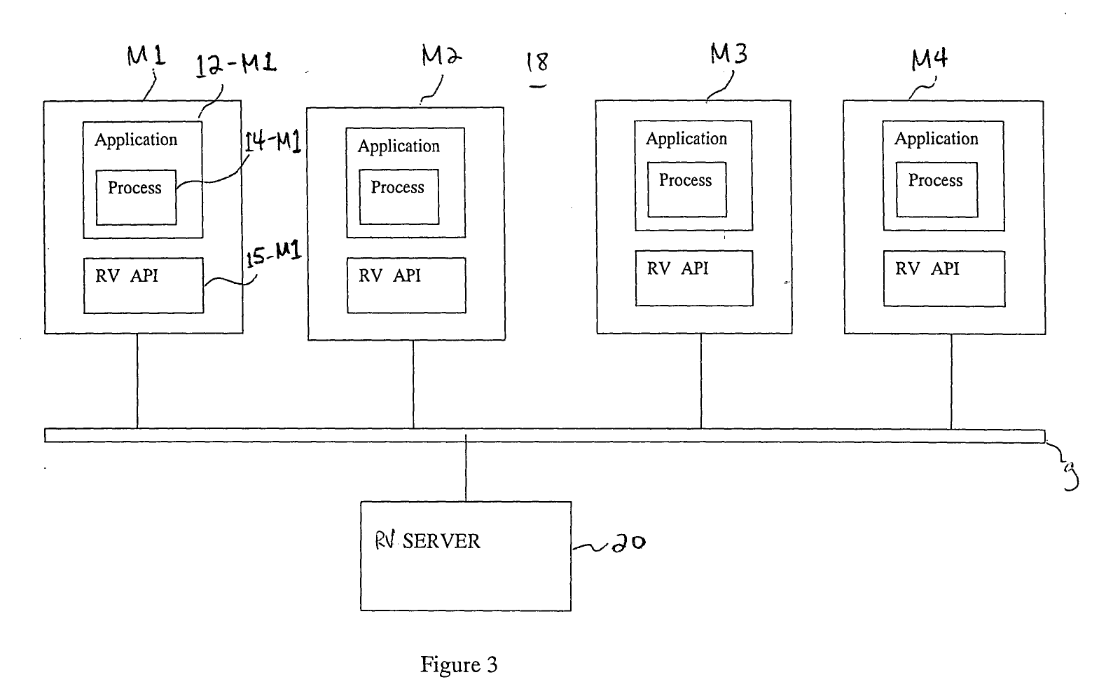

FIG. 3 is the general diagram of a distributed computer system 18 with a “synchronization” or “rendezvous” (RV) server 20 according to one embodiment of the present invention. Server 20 is exemplified by computer system 10 of FIG. 1. In the present embodiment, the distributed computer system 18 includes a group of computer systems (e.g., the computer systems M1, M2, M3, M4) linked together as described above. The computer systems M1-M4 are linked to the RV server 20 through the medium 9. The computer systems (or nodes) M1-M4 may also be called clients in a client-server environment. The RV server 20 is adapted to centralize synchronization requests of the computer systems M1-M4.

For brevity of discussion, the discussion of FIG. 3 focuses on computer system M1; however, the following discussion is extendable to the other computer systems M2-M4. In the present embodiment, computer system M1 includes software layers such as application layer 12-M1; process layer 14-M1, comprising programs which may be in execution (“process” or “processes”); and RV application programming interface (API) layer 15-M1. The RV API layer 15-M1 provides functions to enable computer system M1 to communicate with the RV server 20.

A process in computer M1 system is adapted to call a synchronization request function in the RV API 15-M1. This process is referred to herein as a “calling process.” The synchronization request function is adapted to establish a link between the computer system M1 and the RV server 20, to control input parameters, to send synchronization request messages, and to receive and interpret information messages from the RV server 20, for example.

More specifically, execution adaptation between certain processes in a distributed computer system utilizes a code instruction for a synchronization request function call defined in those processes. This code instruction provides a “rendezvous” identifier that identifies a particular execution adaptation between certain processes. A rendezvous indicator may also be referred to herein as a node meeting indicator.

The code instruction also can cause the calling process to call the synchronization request function in the RV API 15, in order to send a synchronization request message to the RV server 20. The synchronization request message defines parameters such as the number of participants, that is, the number of processes participating in the “rendezvous” awaited by the calling process. The condition for a “reached rendezvous” for the calling process is satisfied when the number of received synchronization request messages in the server, each associated with a corresponding process that is a participant to the rendezvous, is equal to or greater than the number of participants awaited by the calling process.

Exhibit A-1 provides an example of a rendezvous between two processes, process 1 and process 2, according to an embodiment of the present invention.

### Exhibit A-1

### Example of a Rendezvous

| Process 1 | Process 2 |
|---|---|
| Instruction | Instruction |
| Instruction | Instruction |
| Instruction | Instruction |
| RV1 | Instruction |
| Instruction | Instruction |
| Instruction | RV1 |
| Instruction | Instruction |

As illustrated in Exhibit A-1, process 1 stops its execution at the “RV1” code instruction and calls a synchronization request function to send a synchronization request message to the RV server 20. Process 1 waits for, for example, another synchronization request message from another process (e.g., process 2), indicating that the other process is a participant in the rendezvous RV1. Process 2 also stops its code execution at the RV1 code instruction, and calls a synchronization request function to send a synchronization request message to the RV server 20. This latter synchronization request message indicates that process 2 is awaiting another synchronization request message from another process (e.g., process 1) that indicates the other process is a participant in the rendezvous RV1. Once both synchronization request messages, indicating the respective processes 1 and 2 are participants in the rendezvous RV1, are in the RV server 20, both processes 1 and 2 reach the rendezvous RV1. Their execution may then continue. The cadence of execution of process 1 may be different from that of process 2. In that case, one process (e.g., process 1) will stop its execution at the RV1 code instruction before the other (e.g., process 2).

Exemplary parameters for a synchronization request function of the RV API layer 15-M1 are provided in Exhibit A-2.

### Exhibit A-2

### Example of Synchronization Request Function Parameters

Parameters of Function: rendez_vous

| Types | Name of parameters |
|---|---|
| char | rv_id |
| long | rv_total_wait_num |
| unsigned int | rv_time_out |
| unsigned int | rv_block |
| unsigned int | participate |
| char | host_name |
| long | port |

The synchronization request function has different entry parameters to define the adaptation of executions (“rendezvous” or “node meeting”) for participating processes:

rv_id: this parameter identifies a given adaptation of executions between at least two processes. Different processes, on different nodes in a distributed computer system, may meet on a particular rendezvous indicated through this identification.

rv_total_wait_num: this parameter is the total number of participants awaited by the calling process for the rendezvous identified by rv_id. In one embodiment, the calling process is counted in this total number if the calling process is a participant to the rendezvous.

rv_time_out: this parameter is the maximal time that the calling process will wait to complete the rendezvous. In one embodiment, a value of zero (0) is used to indicate that the calling process will wait an unlimited amount of time.

rv_block: this parameter indicates if the calling process is blocked until a rendezvous is completed or until the timeout expires, or if the calling process is not blocked. For example, a value different from 0 indicates a blocking rendezvous, meaning the process will interrupt its execution until the rendezvous is attained. On the contrary, a value equal to 0 indicates the calling process is not blocked when this call is executed. In this latter case, the process continues its execution and does not wait for the execution of other processes.

participate: this parameter indicates if the calling process participates in the rendezvous or not. For example, a value different from 0 indicates the calling process participates in the rendezvous. On the contrary, a value equal to 0 indicates the calling process does not participate in the rendezvous.

host_name: this parameter indicates the name of the host where the rendezvous is.

port: this parameter indicates the port on which the rendezvous server is listening.

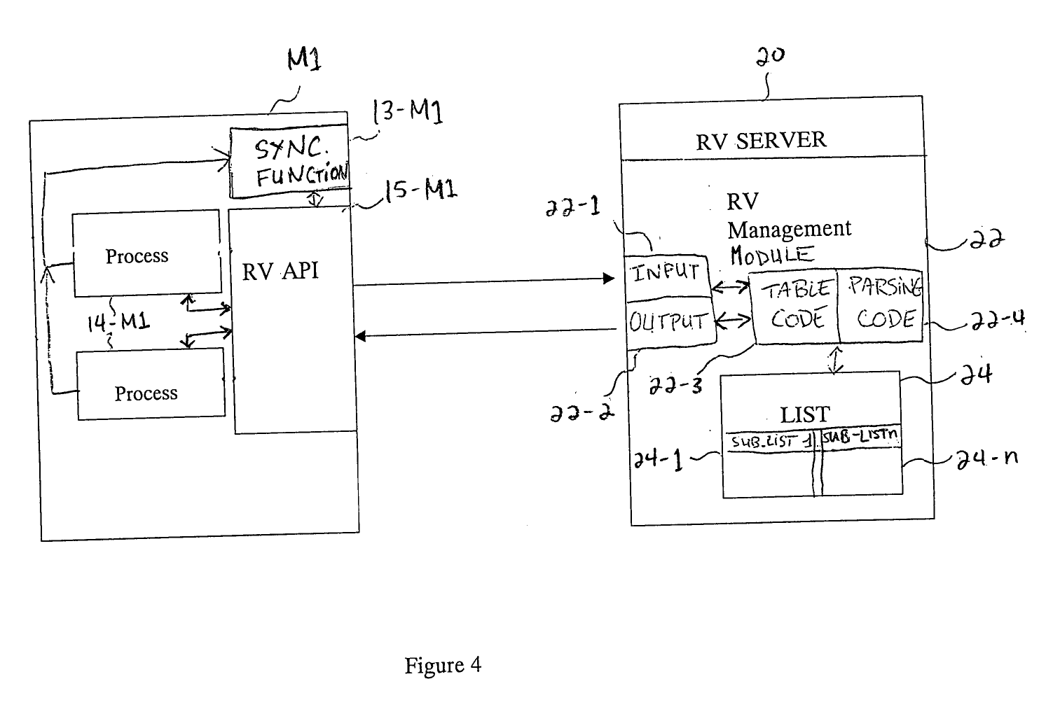

FIG. 4 illustrates the operation of the RV server 20 in relation with a computer system M1 according to one embodiment of the present invention. A calling process 14-M1 of the computer system M1 uses the RV API 15-M1 and the synchronization request function 13-M1 to establish communication with the RV server 20. The synchronization request function 13-M1 sends a connection request to the RV server 20 using, for example, a TCP/IP socket from the RV API 15-M1. This connection request indicates, for example, the host_name parameter and the port parameter of the RV server 20. Responsive to this connection request, the RV server 20 is adapted to establish a connection using a TCP/IP socket (e.g., a socket on the RV server 20 is created and designated for the connection). The connection can be maintained until communication between the process of computer system M1 and the RV server 20 is over.

In one embodiment, the synchronization request function 13-M1 indicates the RV server 20 address and the port identifier in each message sent to the RV server 20. The RV server 20 address and the port identifier are parameters provided by the calling process 14-M1. Then, the process 14-M1 of the computer system M1 uses the RV API 15-M and the synchronization request function 13-M1 to send a synchronization request message to the RV server 20 through the connection.

Exhibit B-1 provides an example of a synchronization request message.

### Exhibit B-1

### Exemplary Synchronization Request Message

| RV ID | RV nbwait | Participant | Blocking |
|---|---|---|---|
| RV3 | 2 | 1 | 1 |

As illustrated in Exhibit B-1, a synchronization request message can include various fields that correspond to at least some of the parameters of the synchronization request function described by Exhibit A-2. For example, the synchronization request message can include values for RV ID, RV total-wait-num, participate, and RV Block. In an embodiment of the invention, the synchronization request function 13-M1 sends a synchronization request message through the connection from the computer of the calling process (e.g., computer system M1) to the RV server 20. The synchronization request message may indicate either the process is a participant in the rendezvous or the process is not a participant in the rendezvous because of, for example, execution problems. By virtue of the computer system M1 sending a synchronization request message with a non-participation indication to the RV server 20, the RV server 20 can release other calling processes that are blocked and waiting for a given number of calling processes to continue their code execution.

The RV server 20 can create different sockets. A given socket may be attributed to a connection between the RV server 20 and the computer of the calling process (e.g., computer system M1). The different sockets are input/output adapted to receive the messages and to return messages as described hereinafter.

The RV server 20 also includes an RV management module 22 that includes, in one embodiment, input code 22-1, table code 22-3, parsing code 22-4, and output code 22-2. Input code 22-1 is for receiving a synchronization request message. Table code 22-3 is for maintaining a list 24 of records, each record including certain of the fields of a received synchronization request message such as the rendezvous identifier and the number of participants. The table code 22-3 counts the number of records having the same rendezvous identifier, and also counts the number of records having the same rendezvous identifier and that indicate a particular process as a participant in the rendezvous.

Parsing code 22-4 checks, responsive to a new received synchronization request message, whether the number of records having the same rendezvous identifier is equal to or greater than RV total-wait-num (the total number of participants awaited by the calling process for the rendezvous identified by RV ID). Output code 22-2, responsive to a record meeting the RV total-wait-num condition, transmits a synchronization-attained message to the calling process 14-M1. The synchronization-attained message includes the number of records having the same rendezvous identifier and indicating the calling process as a participant in the rendezvous.

The RV management module 22 is adapted to create sub-lists in the list 24. Each sub-list stores received synchronization request messages that designate the same rendezvous. Thus, sub-list 24-1 stores synchronization request messages designating, for example, an RV ID1 rendezvous, and sub-list 24-n stores synchronization request messages designating an RV IDn rendezvous.

The synchronization request function 13-M1 is a part of the computer system M1 by way of the above example only. The synchronization request function 13-M1 may also be external to the computer system M1, perhaps residing on the network.

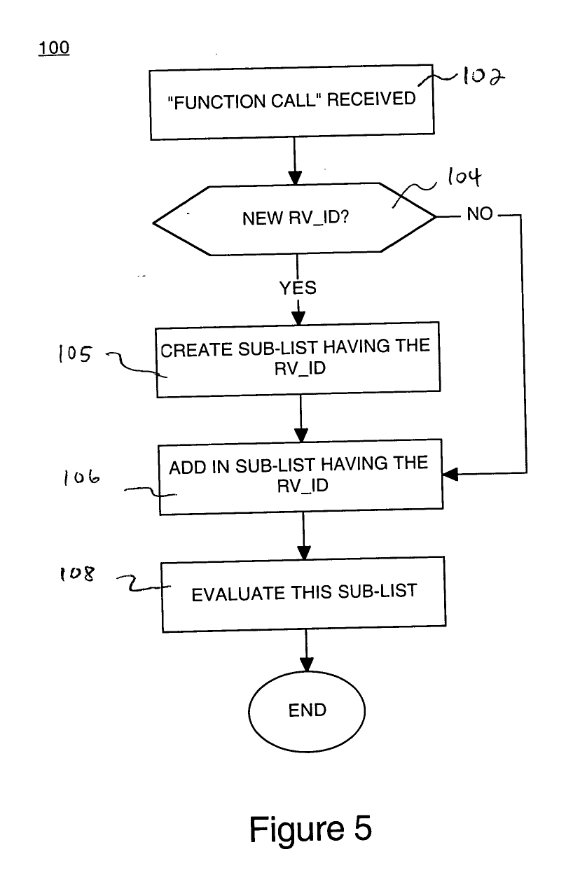

FIG. 5 illustrates a flowchart 100 describing the functions of the RV management module 22 of the RV server 20 (FIG. 4) according to an embodiment of the present invention. At operation 102 of FIG. 5, the RV server 20 receives the synchronization request message from a synchronization request function 13-M1 called by a calling process of a node (e.g., computer system M1 of FIG. 4). In this message, the RV server 20 checks if the identification of the rendezvous (e.g., the RV ID) is new or if it already exists in a sub-list dedicated to records having this RV ID (operation 104). Flowchart 100 either proceeds to operation 105 or 106, depending on the outcome of the check performed in operation 104.

Referring to FIGS. 4 and 5, if the RV ID is new, the RV server 20 creates a new sub-list, dedicates that sub-list to records having the same RV ID (operation 105), and records certain fields of the synchronization request message (operation 106). If the RV ID already exists in a sub-list, the RV server 20 adds the fields of the synchronization request message to the existing sub-list dedicated to records having that RV ID (operation 106).

The RV server 20 counts the total number of records in each sub-list and, in a sub-list, the number of records identifying the calling process 14-M1 as a participant in the rendezvous. For example, the number of records having a participation indication is evaluated by counting the number of records in the sub-list whose participate field indicates a value other than the value 0. After operation 106, the RV server 20 evaluates the sub-list (operation 108). The flowchart 100 restarts at operation 102 if a new synchronization request message is received.

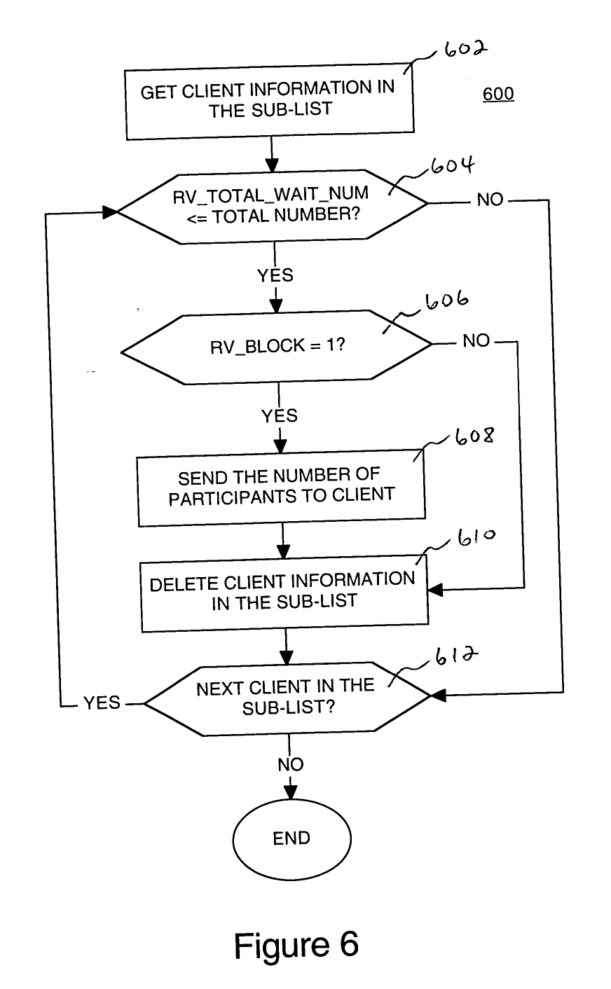

Different cases are considered to evaluate the sub-list at operation 108. These cases are described in flowchart 600 of FIG. 6, which illustrates a method for evaluating a sub-list in the rendezvous server 20 (FIG. 4) according to one embodiment of the present invention.

With reference to FIGS. 4 and 6, at operation 602, the RV management module 22 retrieves the information of the first record in the sub-list. When the RV total-wait-num of the record is greater than the total number of records in the sub-list at operation 604, the flowchart 600 continues at operation 612. Otherwise, the total number of records in the sub-list is equal to or greater than the RV total-wait-num of the record at operation 604, and flowchart 600 proceeds to operation 606.

In operation 606, the RV management module 22 checks whether the RV block field in the record indicates that the calling process 14-M1 is blocked. If it is not, the synchronization request function returns a prescribed value (e.g., 0), as the process 14-M1 is already unblocked (meaning it does not wait for a particular rendezvous to continue its execution). The RV management module 22 deletes this record in the sub-list as the calling process 14-M1 does not wait for any message at operation 610. Otherwise, at operation 608, a synchronization-attained message is transmitted to the calling process 14-M1. More precisely, a synchronization-attained message is transmitted to the synchronization request function 13-M1 corresponding to this record.

The synchronization request function 13-M1 returns the synchronization-attained message to the calling process 14-M1. Thus, the synchronization-attained message (which is the return of the synchronization request function) can indicate to the calling process 14-M1, for example, the total number of records. The synchronization-attained message may advantageously indicate to the calling process 14-M1 the number of records in the sub-list having a participation indication. The synchronization-attained message specifying the number of records having a participation indication enables the calling process 14-M1, which has been blocked to wait for the rendezvous, to make a decision knowing the number of participants and the number of participants awaited by the process. The record of the sub-list is then deleted at operation 610.

If there exists a next record in the sub-list at operation 612, the flowchart continues for this next record at operation 602; otherwise, the flowchart 600 ends. The evaluation of the sub-list may be processed when a synchronization request message is added in the sub-list.

The synchronization request function may also return other values as an error indication. By way of example, the value −1 could be used to indicate an error.

Before establishing a connection with the RV server 20 and sending the synchronization request message to it, the synchronization request function 13-M1 may perform certain controls such as parameter controls (the parameter values are controlled to be positive). If these controls reveal a problem (e.g., a detected error on a parameter), an error message is sent from the synchronization request function 13-M1 to the calling process 14-M1. The error message may be understood as the return of the synchronization request function 13-M1.

The error message may comprise another number, e.g., the errno known in C language (as indicated in “The C programming language”, Brian W. Kernighan, Dennis Ritchie, March 1989). Other types of error may be specified as: a bad identification error (number equal to 301) and/or a bad number error (number equal to 302) and/or a time-out error (number equal to 304) and/or other errors as an error concerning the set of an alarm flag (number equal to 303).

The synchronization request function 13-M1 may launch a clock which counts until a time-out value is reached. If the time-out is reached before a synchronization-attained message is received from the RV server 20, the synchronization request function 13-M1 may return to the calling process 14-M1 an error message specifying the errno number for the time-out error. The error message comprises a value (e.g., −1) and the errno number (e.g., 304).

The Exhibits B-2, B-3 and B-4 illustrate an example of a sub-list at different times T1, T2, T3, where T1<T2<T3. The three synchronization request messages in this example contain fields participate and RV block set to 1.

### Exhibit B-2

### Exemplary Sub-List of Synchronization Request Messages at Time T1

| RV ID | RV nbwait | Participant | Blocking |
|---|---|---|---|
| RV3 | 3 | 1 | 1 |

### Exhibit B-3

### Exemplary Sub-List of Synchronization Request Messages at Time T2

| RV ID | RV nbwait | Participant | Blocking |
|---|---|---|---|
| RV3 | 3 | 1 | 1 |
| RV3 | 2 | 1 | 1 |

### Exhibit B-4

### Exemplary Sub-List of Synchronization Request Messages at Time T3

| RV ID | RV nbwait | Participant | Blocking |
|---|---|---|---|
| RV3 | 3 | 1 | 1 |
| RV3 | 2 | 1 | 1 |
| RV3 | 3 | 1 | 1 |

In Exhibit B-2 and also with reference to FIG. 4, at time T1, the RV server 20 receives a synchronization request message from a synchronization request function called by a calling process of a computer system M1. In this example, RV3 is a new RV ID, so the RV server 20 creates a sub-list and records certain fields of the synchronization request message. In the synchronization request message of the example, RV total-wait-num (RV nbwait) is equal to 3.

In Exhibit B-3, at time T2, the RV server 20 receives a second synchronization request message from a synchronization request function called by a calling process of a computer system M2. As the RV ID of the meeting point is the same as the previous received synchronization request message (RV3), the RV server 20 adds to the sub-list a record having the fields of this second synchronization request message. In the second synchronization request message, RV total-wait-num is equal to 2. The RV server 20 detects that the number of records in the sub-list is equal to the RV total-wait-num of the second synchronization request message. A synchronization-attained message comprising the number of records, and/or the number of records indicating participation, is provided to the synchronization request function at computer system M2. This synchronization request function returns this number to the calling process of computer system M2 that corresponds to the second synchronization request message. This calling process is unblocked and reaches its rendezvous.

In Exhibit B-4, at time T3, the RV server 20 receives a third synchronization request message from a synchronization request function called by a calling process of the computer system M3. As the RV ID of the meeting point (RV3) is the same as the record of the first and second received synchronization request messages, the RV server 20 adds a record having the fields of this third synchronization request message in the sub-list. In this third synchronization request message, RV total-wait-num is equal to 3. The RV server 20 detects that the number of records in the sub-list is equal to the RV total-wait-num of the first and third synchronization request messages. A synchronization-attained message comprising the number of records and/or the number of records indicating participation, is provided to the respective synchronization request functions at computer systems M1 and M3. The synchronization request functions return this number to the respective calling processes at computer systems M1 and M3 that correspond to the first and third synchronization request messages. These calling processes are unblocked and reach their rendezvous.

The RV server 20 may delete a sub-list when the last information message is sent in this sub-list. The last information message indicates that all the records in the sub-list have reached their meeting point or their time-out, and in any case the calling process do not wait anymore for a synchronization request function return.

A calling process may also request special services from the synchronization request function. Thus, the synchronization request function has a command line to request that the RV server 20 delete all the current sub-lists. It also has a standard output (stdout) command line to request that the RV server 20 provide a view on a screen of all current sub-lists.

The RV server 20 may incorporate modifiable parameters such as:

p: the port number on which the RV server 20 listens to the calling processes of the computer machines;

q: the number of synchronization request messages waiting for a connection with the RV server 20;

v: the name of a vervose file, its lowest and upper level log; and

h: the help that a user may require.

Most of the description herein is in the context of a client-server distributed system. However, embodiments of the present invention can also be applied to distributed computer systems using an interaction model other than a client-server model, or between various processes co-existing in a single computer system or node.

Embodiments of the present invention also includes the proposed software code itself, especially when made available on any appropriate computer-readable medium. The expression “computer-readable medium” or “computer-usable medium” includes a storage medium such as magnetic or optic, as well as a transmission medium such as a digital or analog signal.

Embodiments of the present invention have been described. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method for managing code execution synchronization, said method comprising:
receiving a synchronization request message comprising a first node meeting identifier and a number of participants;
maintaining a record of node meeting identifier and number of participants for each of a plurality of received synchronization request message;
checking whether the number of records having said first node meeting identifier in comparison to the number of participants in a record having said first node meeting identifier meets a given condition; and
transmitting a synchronization-attained message when said given condition is met.

2. The method of claim 1, wherein said given condition comprises that said number of records having said first node meeting identifier is equal to or greater than said number of participants in a record having said first node meeting identifier.

3. The method of claim 1, wherein said maintaining comprises creating a table for maintaining records having said first node meeting identifier.

4. The method of claim 1, wherein said maintaining comprises counting said number of records having said first node meeting identifier.

5. The method of claim 1, wherein said synchronization request message comprises a participant/non-participant indication, and wherein said maintaining comprises maintaining a record comprising said participant/non-participant indication of a received synchronization request message.

6. The method of claim 5, wherein said maintaining comprises counting said number of records having said same node meeting identifier and said participant indication.

7. The method of claim 6, wherein said synchronization-attained message comprises said number of records having said same node meeting identifier and said participant/non-participant indication.

8. The method of claim 1, wherein said synchronization request message is adapted to be sent from a synchronization request function on request of a calling process, said calling process providing parameters.

9. The method of claim 8, wherein said synchronization request function is adapted to operate at least one error control on at least one of said provided parameters and, responsive to a detected error on said parameter, to transmit an error message to said calling process.

10. The method of claim 8, wherein said synchronization request message further comprises an unblocked/blocked indication.

11. The method of claim 10, wherein said transmitting further comprises, responsive to a blocked indication, transmitting said synchronization-attained message to said synchronization request function.

12. The method of claim 1, wherein said transmitting further comprises, on receipt of said synchronization-attained message, transmitting a return of said synchronization request function to said calling process if said synchronization request message comprises a blocked indication.

13. A computer-usable medium having computer-readable program code embodied therein for causing a computer system to perform a method for managing code execution synchronization, said method comprising:
receiving a synchronization request message comprising a first node meeting identifier and a number of participants;
maintaining a record of node meeting identifier and number of participants for each of a plurality of received synchronization request message;
checking whether the number of records having said first node meeting identifier in comparison to the number of participants in a record having said first node meeting identifier meets a given condition; and
transmitting a synchronization-attained message when said given condition is met.

14. The computer-usable medium of claim 13, wherein said given condition comprises that said number of records having said first node meeting identifier is equal to or greater than said number of participants in a record having said first node meeting identifier.

15. The computer-usable medium of claim 13, wherein said maintaining comprises creating a table for maintaining records having said first node meeting identifier.

16. The computer-usable medium of claim 13, wherein said maintaining comprises counting said number of records having said first node meeting identifier.

17. The computer-usable medium of claim 13, wherein said synchronization request message comprises a participant/non-participant indication, and wherein said maintaining comprises maintaining a record comprising said participant/non-participant indication of a received synchronization request message.

18. The computer-usable medium of claim 17, wherein said maintaining comprises counting said number of records having said same node meeting identifier and said participant indication.

19. The computer-usable medium of claim 18, wherein said synchronization-attained message comprises said number of records having said same node meeting identifier and said participant/non-participant indication.

20. The computer-usable medium of claim 13, wherein said synchronization request message is adapted to be sent from a synchronization request function on request of a calling process, said calling process providing parameters.

21. The computer-usable medium of claim 20, wherein said synchronization request function is adapted to operate at least one error control on at least one of said provided parameters and, responsive to a detected error on said parameter, to transmit an error message to said calling process.

22. The computer-usable medium of claim 20, wherein said synchronization request message further comprises an unblocked/blocked indication.

23. The computer-usable medium of claim 22, wherein said transmitting further comprises, responsive to a blocked indication, transmitting said synchronization-attained message to said synchronization request function.

24. The computer-usable medium of claim 13, wherein said transmitting further comprises, on receipt of said synchronization-attained message, transmitting a return of said synchronization request function to said calling process if said synchronization request message comprises a blocked indication.

25. A computer system comprising:
a memory unit; and
a processor coupled to said memory unit, said processor for executing a method for managing code execution synchronization, said method comprising:
receiving a synchronization request message comprising a first node meeting identifier and a number of participants;
maintaining a record of node meeting identifier and number of participants for each of a plurality of received synchronization request message;
checking whether the number of records having said first node meeting identifier in comparison to the number of participants in a record having said first node meeting identifier meets a given condition; and
transmitting a synchronization-attained message when said given condition is met.

26. The computer system of claim 25, wherein said given condition comprises that said number of records having said first node meeting identifier is equal to or greater than said number of participants in a record having said first node meeting identifier.

27. The computer system of claim 25, wherein said maintaining comprises creating a table for maintaining records having said first node meeting identifier.

28. The computer system of claim 25, wherein said maintaining comprises counting said number of records having said first node meeting identifier.

29. The computer system of claim 25, wherein said synchronization request message comprises a participant/non-participant indication, and wherein said maintaining comprises maintaining a record comprising said participant/non-participant indication of a received synchronization request message.

30. The computer system of claim 29, wherein said maintaining comprises counting said number of records having said same node meeting identifier and said participant indication.

31. The computer system of claim 30, wherein said synchronization-attained message comprises said number of records having said same node meeting identifier and said participant/non-participant indication.

32. The computer system of claim 25, wherein said synchronization request message is adapted to be sent from a synchronization request function on request of a calling process, said calling process providing parameters.

33. The computer system of claim 32, wherein said synchronization request function is adapted to operate at least one error control on at least one of said provided parameters and, responsive to a detected error on said parameter, to transmit an error message to said calling process.

34. The computer system of claim 32, wherein said synchronization request message further comprises an unblocked/blocked indication.

35. The computer system of claim 34, wherein said transmitting further comprises, responsive to a blocked indication, transmitting said synchronization-attained message to said synchronization request function.

36. The computer system of claim 25, wherein said transmitting further comprises, on receipt of said synchronization-attained message, transmitting a return of said synchronization request function to said calling process if said synchronization request message comprises a blocked indication.
